(19) United States
(12) Patent Application Publication
(10) Pub. No.: US 2008/0222576 A1
(43) Pub. Date: Sep. 11, 2008

(54) DESIGN SUPPORT APPARATUS, METHOD FOR SUPPORTING DESIGN, AND MEDIUM RECORDING DESIGN SUPPORT PROGRAM

(75) Inventor: Michitaka Hashimoto, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/042,076

(22) Filed: Mar. 4, 2008

(30) Foreign Application Priority Data
Mar. 7, 2007 (JP) JP2007-056827

(51) Int. Cl. G06F 17/50

(52) U.S. Cl. 716/1

(57) ABSTRACT

A design support apparatus and method generating design data of a circuit and updating the design data, storing the design data and update history data representing an update content in association with an updated circuit component when the design data is updated. The disclosed apparatus and method include receiving an extraction criterion for extracting a particular piece of update history data from among a plurality of pieces of update history data, extracting the update history data from the history database in accordance with the extraction criterion, and restoring an original design data of the circuit before updating as represented by the extracted update history data.

### CROSS-REFERENCE TO RELATED APPLICATIONS

This application is related to and claims the benefit of priority from Japanese Patent Application No. 2007-056827, filed on Mar. 7, 2007, the entire contents of which are incorporated herein by reference.

### BACKGROUND

1. Field

The present invention relates to an apparatus for design support, a method for supporting design, and a medium recording design support program executed in the apparatus.

2. Description of the Related Art

In recent years, circuit scale of large-scale integrated (LSI) circuits has increased and development period needed for LSI circuits has also increased. Developments of LSI circuits include manual layout design. Often, in manual layout design of LSI circuits, in order to reduce the period needed for development, a plurality of operators perform operations, such as arrangement and wiring, for the same block at the same time.

However, since a plurality of operators perform operations on the same design data, it is difficult for all the operators in charge of the design data to have a common understanding of an operation status. For example, not all update information (for example, what was updated when, by whom, and for what purpose) can be conveyed to all the operators by mail or orally. Thus, a failure in delivery of an announcement inevitably occurs. In such a circumstance, an operator who does not receive update information may update a portion that should not be updated because layout processing has already been carried out. In such a case, design data of an unexpected layout is generated, and the original layout before the updating was performed may have to be restored.

In developments of LSI circuits in recent years, it is rare that logic verification is completed by the start of layout design. In general, logic verification and layout design are performed simultaneously. Thus, at the time of layout design, a logic failure may be detected as a result of logic verification. In order to remedy such a failure, a logic change is required. As a result, design data of layout design may have to be restored to a state that was present at a certain time prior to the current time (before layout design having the logic failure was performed, for example, a few days or a few weeks prior to the current time).

In the case of restoring design data of layout design to a state that was present at a predetermined point in time, data existing prior to the current time may be stored in a disk. However, in developments of recent years, since the circuit scale of LSI circuits has increased, data existing prior to the current time (for example, a few weeks) is unlikely to be stored. Thus, if design data of a desired point in time is not stored, past update information is restored on the basis of existing design data in accordance with records of information exchanges and update instructions using mail or the like or in accordance with memory of operators in charge. Accordingly, a large number of man-hours are required for the restoration. In addition, it is unlikely that a state present before all the past updating was performed can be restored by a single operation. In the worst case, a repetition of similar operations is necessary, which requires a large number of man-hours.

In the above-described technology, information indicating what type of updating was performed for design data of layout design when, by whom, and for what purpose is not available. Thus, for example, if restoration of a layout state is required due to an unsuccessful operation, a logic change, or the like, a large number of man-hours are required.

In addition, an operator who is different from a usual operator in charge may have to perform further updating of data that has already been updated. In this case, if the present operator does not know the reason why the previous operator performed the previous updating, the present operator may perform updating that is not intended by the usual operator. In this case, additional operation for restoring the original state before the unintended updating was performed is also required.

In order to solve the above-described problems, update history data may be generated as text. However, in order to reflect the update history data on a layout, a manual operation must be performed using a layout editor while referring to the text of the update history data. Thus, a large number of man-hours are required.

In addition, in order to solve the above-described problems, layout data of a few generations prior to the current time may be backed up. However, since the circuit scale of recent LSI circuits is large, the capacity of a storage device, such as a hard disk, may not be sufficient. In addition, in this method, a state that was present before the data was backed up cannot be restored.

Accordingly, it is an object of the present invention to provide a technology using which a plurality of operators in charge are able to understand an operation status, an operation purpose, and the like of layout design and using which design data at a desired point in time can be restored in accordance with history data of an operation without requiring a manual layout-design operation.

### SUMMARY

The disclosed design support apparatus includes an editor generating design data of a circuit including circuit components and a line connecting the circuit components and updating the design data, a design database storing the design data of the circuit, a history database storing, when the design data is updated, update history data representing an update content in association with an updated circuit component or an updated line in the design data.

The design support apparatus includes an extraction criterion receiver receiving an extraction criterion for extracting a particular piece of update history data from among a plurality of pieces of update history data stored in the history database, a history data extractor extracting the update history data from the history database in accordance with the extraction criterion, and a restoring unit restoring an original design data of the circuit before the updating as represented by the update history data extracted.

Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 illustrates functional blocks of a design support apparatus;

FIG. 2 illustrates an overview of operations performed when a design support apparatus performs layout design;

FIG. 3 illustrates examples of commands for a rule file;

FIG. 4 illustrates an example of a user-defined file;

FIG. 5 illustrates examples of commands for a command file;

FIG. 6A illustrates a data structure of history data;

FIG. 6B illustrates an example of a line;

FIG. 7 illustrates an example of a history reference screen;

FIG. 8 is a flowchart of a layout data update process including a history data storing function (operation);

FIG. 9 is a flowchart of a history data selection process;

FIG. 10 schematically illustrates a processing for restoring design data to a state present at a certain time prior to a current time;

FIG. 11 is a flowchart of a restoration process; and

FIG. 12 illustrates an example of processing for performing simulation that reflects a particular updating.

### DETAILED DESCRIPTION OF THE PREFERRED EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

A design support apparatus according to a best mode for carrying out the present invention (hereinafter, referred to as an embodiment) will be described with reference to the drawings. The embodiments described below are merely examples, and the present invention is not limited to any of the embodiments described below.

A design support apparatus according to an embodiment of the present invention includes a layout editor and allows a user to manually arrange circuit components and a line connecting the circuit components. Hereinafter, arranging circuit components and a line connecting the circuit components is called “layout processing”, In addition, design at this stage is called “layout design”. As a result of layout design, design data is generated, and the generated design data is stored into a layout database. Hereinafter, as an example of a circuit component, for example, a gate including a plurality of transistors will be explained. For example, a gate is a circuit component implementing a logic operation, such as AND, OR, NAND, NOR, NOT, or the like. In addition, each line is also called a net.

In addition to allowing manual arrangement and wiring, the design support apparatus provides, for each gate in the case of arrangement and for each net in the case of wiring, in each portion in which arrangement or wiring is performed, history data including an operation date (for example, updated date), an operator (for example, user name or other identifier of a user), and an update content (for example, a collection of a plurality of pieces of history data corresponding to a history database) and storing history data into a layout database. In this case, in accordance with an identifier indicating a gate (hereinafter, also referred to as a “cell name”) or an identifier indicating a net, design data in the layout database is linked to history data. However, a history database in which update contents are recorded may be different from the layout database.

For operations of the design support apparatus, in a case where a plurality of operators perform operations on the same layout block, one of the operators may be selected as a block layout manager (hereinafter, referred to as a manager). The manager is responsible for setting and updating of control information of the design support apparatus, and other operators may not be able to update control information. Control information exemplifies definition contents of a rule file, a user-defined file, a command file, etc.

A rule file defines an update command entered by a user to designate an update content. The user instructs the design support apparatus to update design data using an update command defined in the rule file. The update command designates, for example, an addition of a gate, a change in a size of a gate, a deletion of a gate, or the like. The update command may also designate addition of a line, a change in a size of a line, a change of a layer to which a line belongs, a deletion of a line, etc.

A user-defined file stores an identifier of a user who is able to use the design support apparatus (hereinafter, referred to as a user name). As a user name, an identifier is registered in the user-defined file by the manager before layout processing. A user whose identifier has not been registered cannot use the design support apparatus or access the layout database. Although an identifier of a user is described as a user name, the disclosed invention is not limited to any particular type of identifier and other identifier(s) uniquely identifying a user may be used.

A command file defines a history operation command in a case where a user performs an operation in relation to history data. As described above, in advance, that is, before the user performs layout processing, a manager defines commands for the rule file and the command file in accordance with a predetermined naming rule.

The design support apparatus records a history record such that, in accordance with a command entered by a user, a gate, a line, or the like to be subjected to layout processing is associated with a corresponding command. The user performs operations on design data and history data under constraints of the rule file and the command file defined in advance. Thus, an update content is recorded as history data in accordance with definitions of the rule file and the command file. In contrast, designation of an update content not defined in the rule file or the command file cannot be input to the design support apparatus. Thus, updating of design data with such an arbitrary operation cannot be achieved. In addition, a history record of updating for such an undefined command is not stored in the layout database.

In addition, in the design support apparatus, even when updating is performed for the same gate or the same line a plurality of times, each of update contents is stored as history data in the layout database. In addition, using the layout editor, an operator is able to visually understand an updated date, a user name, an update content, etc. Here, the user can make a selection between display and non-display and a designation of a number of items to be displayed. That is, although the default number of items to be displayed is fixed, the user is able to change the number of items to be displayed by entering a command according to need. Accordingly, the number of items to be displayed can be temporarily changed and customized. However, the user cannot change the default setting.

Since update history records are stored in the layout database, the user may designate a single piece or a plurality of pieces of information related to an updated date, an operator who performed updating, an update content. With this designation, history data is selected. Then, design data associated with the selected history data is selected. Accordingly, the user is able to designate history data and extract only design data that is associated with the designated history data. Thus, an update content associated with a particular history record can be extracted and deleted, and design data not including such updating can be restored.

In addition, since an operator is able to view and understand an updated date, a user name, and an update content, an unsuccessful operation can be prevented.

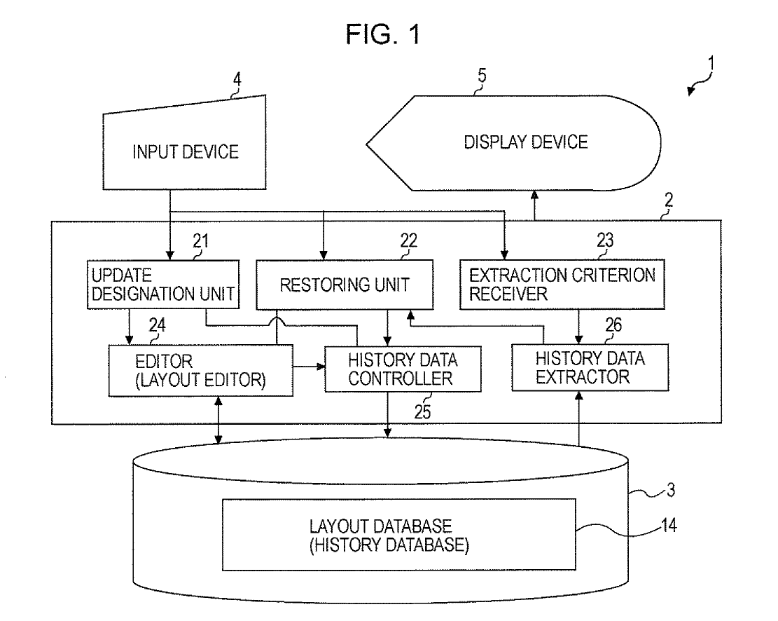

FIG. 1 is a block diagram showing a design support apparatus (information processing apparatus) 1 according to an embodiment of the present invention. The design support apparatus 1 includes a controller 2 that implements functions of the design support apparatus 1, a hard disk 3 including a layout database (history database) 14 controlled by the controller 2, an input device 4 that receives a user operation input by a user who operates the design support apparatus 1, and a display device 5 that displays data processed by the controller 2.

The controller 2 may include a central processing unit (CPU), a memory, and various interfaces (not shown) enabling operations of the controller 2 to be implemented. In the controller 2, a program is loaded into a memory and is executed by the CPU. Thus, each functional block of the design support apparatus 1 can be implemented by a program running on a computer. This program cooperates with an editor (layout editor) 24 to support LSI layout design. The editor 24 may be a layout editor implementing LSI computer-aided design (CAD).

The layout database 14 stores LSI design data generated by the editor 24. The layout database 14 contains history data, which is an update history record indicating updating of design data.

The layout database 14 is contained in the hard disk 3, which may be connected to the CPU of the controller 2 with a predetermined interface therebetween. In addition, another external storage device, for example, a driving device for a removable recording medium, such as a compact disc (CD), a digital versatile disc (DVD), or a flash memory, may also be connected to the controller 2.

The input device 4 includes, for example, a keyboard and a pointing device. The input device 4 is also connected to the CPU of the controller 2 with a predetermined interface therebetween. The display device 5 is, for example, a liquid crystal display. The display device 5 is also connected to the CPU of the controller 2 with a predetermined interface therebetween. In addition, a communication interface allowing access to a network is also connected to the controller 2.

Referring to FIG. 1, the controller 2 includes functional blocks, that is, an update designation unit 21, a restoring unit 22, an extraction criterion receiver 23, the editor 24, a history data controller 25, and a history data extractor 26.

The update designation unit 21 receives a command input by a user through the input device 4. The update designation unit 21 updates design data in the layout database 14 through the editor 24. The update designation unit 21 notifies the history data controller 25 of an update content. The update content is associated with an updated circuit component or an updated line in design data.

The editor 24 may be a layout editor. The editor 24 generates an LSI layout in accordance with a user operation and stores the generated layout into the layout database 14. In addition, the editor 24 updates design data stored in the layout database 14 in accordance with an instruction issued from the update designation unit 21.

The history data controller 25 generates history data in accordance with an update content reported by the update designation unit 21 and stores the generated history data into the layout database 14. A collection of a plurality of pieces of history data is also referred to as a history database.

The extraction criterion receiver 23 receives, through the input device 4, an extraction criterion for history data to be extracted from the history database. An extraction criterion is defined in accordance with a date on which design data was generated, a date on which design data was updated, a person who generated design data, a name of a cell contained in design data, a name of a line, a parameter designated when design data was generated or updated, or the like.

The history data extractor 26 extracts corresponding history data from the history database in accordance with an extraction criterion received from the extraction criterion receiver 23.

The restoring unit 22 restores design data at a predetermined point in time in accordance with history data extracted by the history data extractor 26. That is, the restoring unit 22 deletes an update content corresponding to a particular history data and updates design data in the layout database 14 such that updating corresponding to the particular history data does not exist and the design data reverts back to a state prior to the updating. In this case, a restored content is reported to the history data controller 25. Thus, the restored content is stored as history data.

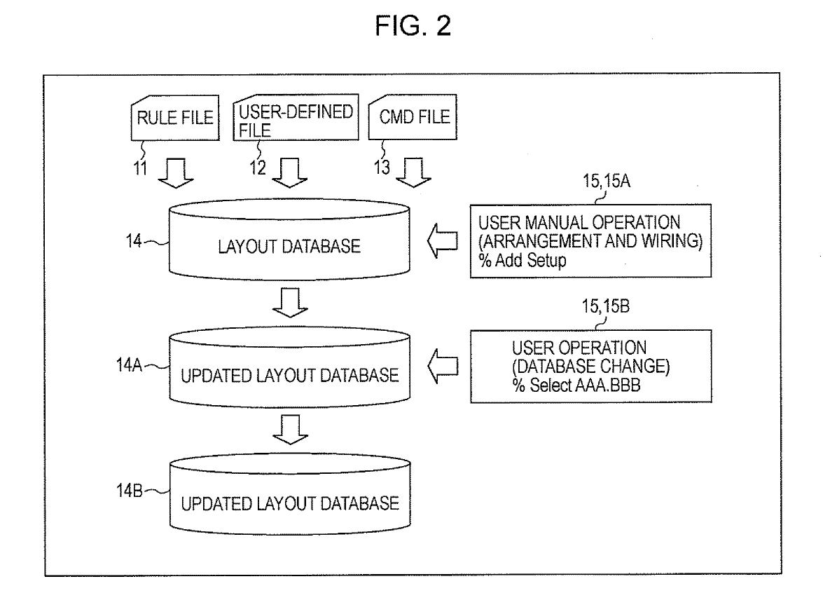

The design support apparatus 1 according to an embodiment of the present invention is described below with reference to FIGS. 2 to 12.

Overview of Processing

FIG. 2 illustrates an overview of operations performed when the design support apparatus 1 performs layout design. As shown in FIG. 2, the design support apparatus 1 displays on the display device 5 a command entry screen (window) 15 that urges a user to enter a command. The user enters a command in response to a prompt appearing on the command entry screen 15, thus defining an update content for the layout database 14. In FIG. 2, when all the screens are named generically, the generic term, command entry screen 15, is used. In contrast, when a concrete screen is specified, the term “command entry screen 15A” or “command entry screen 15B” is used.

The update designation unit 21 of the design support apparatus 1 updates the layout database 14 in accordance with an update content defined by a command entered using the command entry screen 15. In this case, in accordance with a rule file 11, a user-defined file 12, and a command file (CMD) 13, the design support apparatus 1 checks for an update content entered by the user. When an undefined command is entered by the user, an error message indicating that the command is not acceptable is indicated. Accordingly, the design support apparatus 1 prohibits an arbitrary user operation.

If a command entered by the user is in accordance with the rule file 11, the user-defined file 12, and the command file 13, the design support apparatus 1 updates design data through the editor 24 in accordance with the entered update content. Although not illustrated, history data representing the update content is also stored in the layout database 14.

Referring to FIG. 2, a command “Add Setup” is entered on the command entry screen 15A. For example, this command indicates that a gate or a line is added in order to avoid setup errors. The contents of the layout database 14 are updated in accordance with the entry of the command, and an updated layout database 14A is generated.

In FIG. 2, it is assumed that a designation of a type of gate or line and a designation of the place where the gate or the line is to be added have already been made before the entry of the command “Add Setup”. For example, the command “Add Setup” is entered in combination with a command designating a name of a cell of a gate to be added and a command designating the place where the gate is to be added. Thus, the command “Add Setup” shown in FIG. 2 means that a gate or a line that is being processed by the editor 24 is added to the layout database 14. Other commands perform designation in a similar manner.

However, such a command system of a layout editor is not necessarily used in the present invention. That is, together with a command designating addition, a designation of a type of gate or line and a designation of a place where the gate or the line is to be added may be made using parameters. For example, a name of a cell of a gate to be added, a place where the gate is to be added (X1,X2), and a reason for addition (countermeasure against setup errors) can be designated, as in “Add, the name of cell, X1, Y1, Setup”.

The extraction criterion receiver 23 of the design support apparatus 1 extracts history data from the layout database 14 in accordance with a command entered through the input device 4.

An example where particular history data is extracted in accordance with a “Select” command is shown by the command entry screen 15B shown in FIG. 2. In this example, a parameter AAA.BBB designates an object to be extracted. In this example, a command indicating restoration is omitted. For example, when a “Delete” command for deleting a currently selected gate or line is designated after the “Select” command, the design support apparatus 1 performs processing for restoring the gate or the line corresponding to the extracted history data to an original state. Thus, the design support apparatus 1 performs processing for restoring the original design data before updating was performed. Accordingly, an updated database 14B obtained by restoration to the original state before updating is generated.

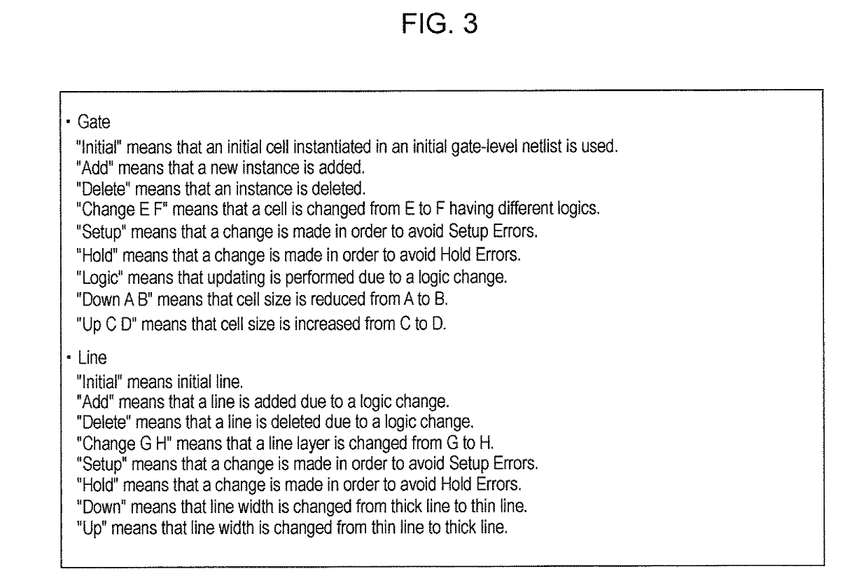

FIG. 3 shows examples of update commands for the rule file 11 illustrated in FIG. 2. In FIG. 3, update commands are classified into operation commands for a gate (commands written below the character string “Gate”) and operation commands for a line (commands written below the character string “Line”). Examples of typical update commands are described below.

An “Initial” command indicates that a gate defined in the initial gate-level netlist (also referred to as an initial cell) is used. That is, a gate having default attributes (the type of gate, the size, and the like) before updating is used.

An “Add” command indicates that a new instance is added. The “Add” command designates a name of a cell of an instance to be added and a place where the instance is to be added. The term “instance” indicates concrete data of a gate or a line. The attributes of a cell to be added are defined in accordance with an operation of the editor 24 before the entry of the “Add” command.

A “Delete” command indicates that a designated instance was deleted. The “Delete” command designates a name of a cell of an instance to be deleted.

A “Change E F” command indicates that a cell that is being processed is changed from E to F having different logics. For example, a “Change AND NAN D” command indicates that an AND gate is changed to a NAND gate.

A “Setup” command indicates that a change is made in order to avoid setup errors. Setup errors occur, for example, when the time from setting of data for a set terminal or a reset terminal to be input to a gate (a gate forming a flip-flop) to inputting of a clock is too short.

A “Hold” command indicates that a change is made in order to avoid hold errors. Hold errors occur, for example, when after a clock is input, the maintenance time of data for a set terminal or a reset terminal to be input to a gate is short.

A “Logic” command indicates that updating is performed due to a logic change. A “Down A B” command indicates that a size of a cell is reduced from A to B. An “Up C D” command indicates that a size of a cell is increased from C to D.

Commands for a line for the rule file 11 are described next. An “Initial” command indicates that an initial line is used. That is, for example, a line having default attributes is added.

An “Add” command indicates that a line is added due to a logic change or the like. Although omitted in FIG. 3, attributes of a line (an identifier, a width of the line, a place where a line is to be added, and the like) are designated before the “Add” command. However, the attributes of the line may be designated as parameters, together with the “Add” command.

A “Delete” command indicates that a line is deleted due to a logic change or the like. A line to be deleted is designated before the “Delete” command. However, a line to be deleted may be designated as a parameter of the “Delete” command.

A “Change G H” command indicates that a line layer is changed from G to H. Although omitted in FIG. 3, an identifier of a line to be changed is designated before the “Change” command. However, the identifier of the line may be designated as a parameter, together with the “Change” command.

A “Down” command indicates that a width of a line that is being processed is changed from a thick line to a thin line. An “Up” command indicates that a width of a line that is being processed is changed from a thin line to a thick line.

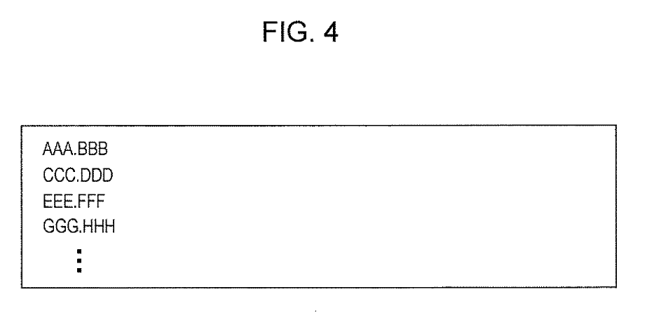

FIG. 4 shows an example of the user-defined file 12 illustrated in FIG. 2. User names are listed in the user-defined file 12. In the case of performing layout design, the design support apparatus 1 urges a user to enter a user name. If a user name that is not defined in the user-defined file 12 is entered, an operation performed by the user is rejected.

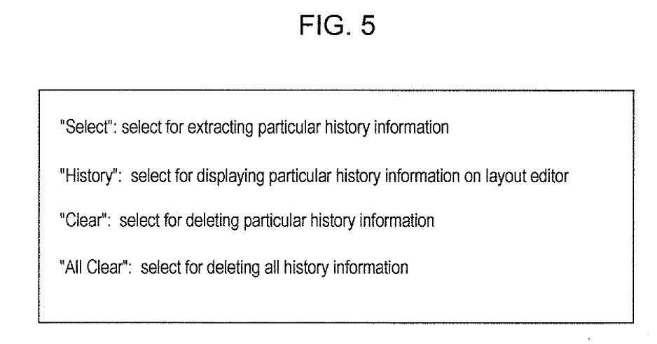

FIG. 5 shows examples of commands of the command file 13 illustrated in FIG. 2. Main commands are described below. A “Select” command is designated for extracting particular history information. A “History” command is designated for displaying particular history information on the editor 24.

A “Clear” command is designated for deleting a designated history information and for restoring the original design data before updating of design data corresponding to the deleted history data was performed. History information to be deleted is designated by a parameter of the “Clear” command. A parameter of the “Clear” command is, for example, a date, a period, a user name, or the like.

An “All Clear” command is designated for deleting all the history information and for restoring the original design data before all the updating was performed.

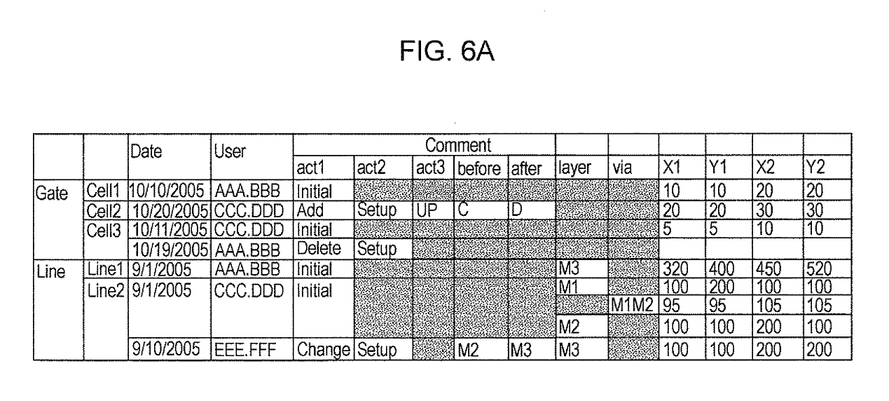

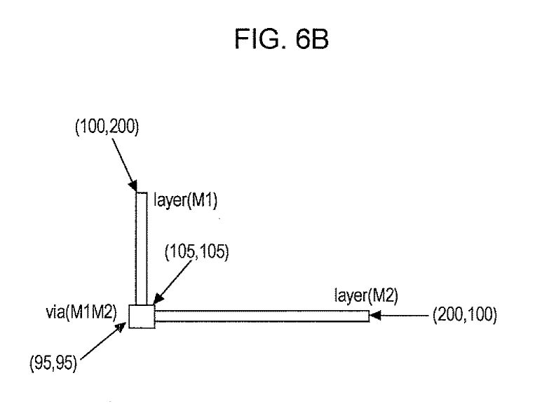

FIG. 6A shows a data structure of history data stored in the design support apparatus 1. In the example shown in FIG. 6A, history data is illustrated in a table format. However, history data is not necessarily described in a table format. For example, history data may be described using a tag based on an extensible markup language (XML).

Referring to FIG. 6A, history records for gates and history records for lines are stored separately. A history record is described in a row in the table. A history record for a gate includes a cell name (for example, “Cell1”), an updated date, a name of a user who performed updating, a comment, and other parameters. The cell name is a name for identifying an updated gate.

A “comment” includes an action 1 (described as “act1”), an action 2 (described as “act2”), an action 3 (described as “act3”), a value before updating (described as “before”), and the value after updating (described as “after”). The other parameters are, for example, designation of a layer (described as “layer”), designation of a type of via-hole (described as “via”), and designation of coordinates (described as “X1,Y1,X2,Y2”).

Here, “act1”, “act2”, “act3”, “before”, and “after” are information entered by a user. In contrast, “layer”, “via”, “X1”, “Y1”, “X2”, and “Y2” can be acquired from the editor 24 by a program that executes the processing (the history data controller 25 in FIG. 2). The editor 24 has a function of a normal layout editor and is capable of displaying an object of a gate or a line. Thus, the editor 24 holds the coordinates of the gate or the line.

In addition, the coordinates (X1,Y1 X2,Y2) of a gate represents a range where cells forming the gate exist (the lower-left point X-coordinate, the lower-left point Y-coordinate, the upper right point X-coordinate, and the upper-right point Y-coordinate). The coordinates also represent the coordinates of a position where the cells are disposed. In contrast, the coordinates (X1,Y1,X2,Y2) for a line represents a start point (X1,Y1) and an end point (X2,Y2) of the line.

For example, it is clear from FIG. 6A that a gate described as “Cell1” was disposed at the coordinates (10,10,20,20) with the default attributes (initial) by a user whose user name is AAA.BBB on Oct. 10, 2005.

It is also clear from FIG. 6A that a gate described as “Cell2” was added (act1=Add) in order to avoid setup errors (act2=Setup), the size of the “Cell2” was increased (act3=Up), the sizes before and after updating are recorded (before=C, after=D), and the gate was disposed at the coordinates (20,20,30,30) by a user whose user name is CCC.DDD on Oct. 20, 2005.

Similarly, as shown in FIG. 6A, the fact that a gate described as “Cell3” was disposed at the coordinates (5,5,10,10) in accordance with the default attributes by the user CCC.DDD on Oct. 11, 2005 and that the gate was deleted in order to avoid setup errors on Oct. 19, 2005 (act1=Delete) is recorded. In this case, although history data of processing until deletion is held, a deleted object is excluded from an object to be edited. In addition, a field for the coordinates (X1,Y1,X2,Y2) representing the range where cells exist is empty.

Similarly, as shown in FIG. 6A, a line whose identifier is “Line1” was disposed at the coordinates (320,400,450, 520), which represents the start point X-coordinate, the start point Y-coordinate, the end point X-coordinate, and the end point Y-coordinate, in a layer M3 in accordance with the default attributes by the user AAA.BBB on Sep. 1, 2005.

In addition, as shown in FIG. 6A, a line whose identifier is “Line2” is connected through a via-hole between the layers M1 and M3 in accordance with the standard attributes. In this case, a line is disposed at the coordinate (100,200,100,100), which represents the start point X-coordinate, the start point Y-coordinate, the end point X-coordinate, and the end point Y-coordinate, in the layer M1. In addition, a line is disposed at the coordinates (100,100,200,100), which represents the start point X-coordinate, the start point Y-coordinate, the end point X-coordinate, and the end point Y-coordinate, in the layer M3. In addition, the coordinates (150,150,160,160) represent the lower-left point and the upper-right point of the via-hole. The structure of lines in this case is shown in FIG. 6B.

However, for the line “Line2”, a change from the layer M2 to the layer M3 was made in order to avoid setup errors by a user EEE.FFF on Sep. 5, 2005.

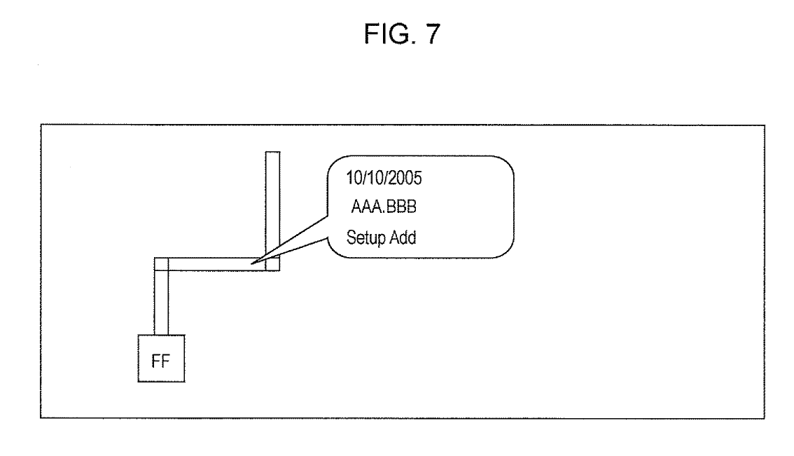

FIG. 7 shows an example of a history reference screen. In this example, a case where a particular line is selected and a “History” command is designated is assumed. This example illustrates that a line shown in FIG. 5 was added in order to avoid setup errors by the user AAA.BBB on Oct. 10, 2005.

An information processing program performed by the design support apparatus 1 extracts history data designated by a “Select” command. In response to the entry of a “History” command, the history data is displayed near a corresponding instance. Alternatively, for example, after a user selects an instance using a pointing device, history data corresponding to the instance may be displayed in response to the entry of a “History” command.

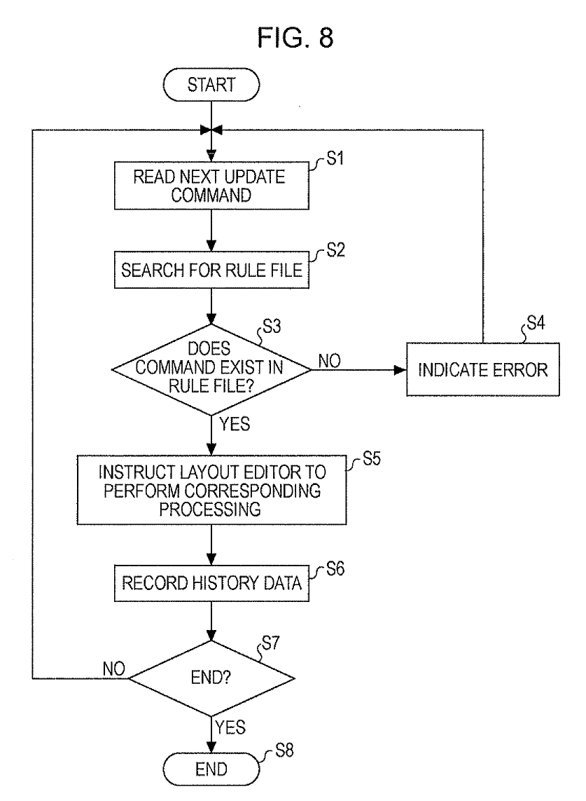

FIG. 8 is a flowchart of a layout data update process including a history data storing function. The layout data update process is performed by the history data controller 25, which cooperates with the layout editor, in the CPU of the design support apparatus 1.

The design support apparatus 1 reads a next update command (operation S1). An update command is entered by a user through the command entry screen 15 shown in FIG. 2.

The design support apparatus 1 searches for the rule file 11 (operation S2). The design support apparatus 1 determines whether the update command entered in operation S1 is defined in the rule file 11 (operation S3). If it is determined in operation S3 that the entered update command is not defined in the rule file 11, the design support apparatus 1 indicates an error message (operation S4).

If it is determined in operation S3 that the entered update command is defined in the rule file 11, the design support apparatus 1 requests the editor 24 to perform processing corresponding to the entered update command (operation S5). Accordingly, updating of design data is performed. For example, a size change, addition or deletion of a gate, or the like is performed in order to avoid setup errors.

The design support apparatus 1 records an update content as history data into the layout database 14 (operation S6). Here, history data is stored into the layout database 14 in accordance with a format illustrated in FIG. 6A.

Then, the design support apparatus 1 determines whether an instruction to terminate the update process has been issued (operation S7). If it is determined in operation S7 that an instruction to terminate the update process has not been issued, the design support apparatus 1 returns to operation S1. If it is determined in operation S7 that an instruction to terminate the update process has been issued, the design support apparatus 1 terminates the process.

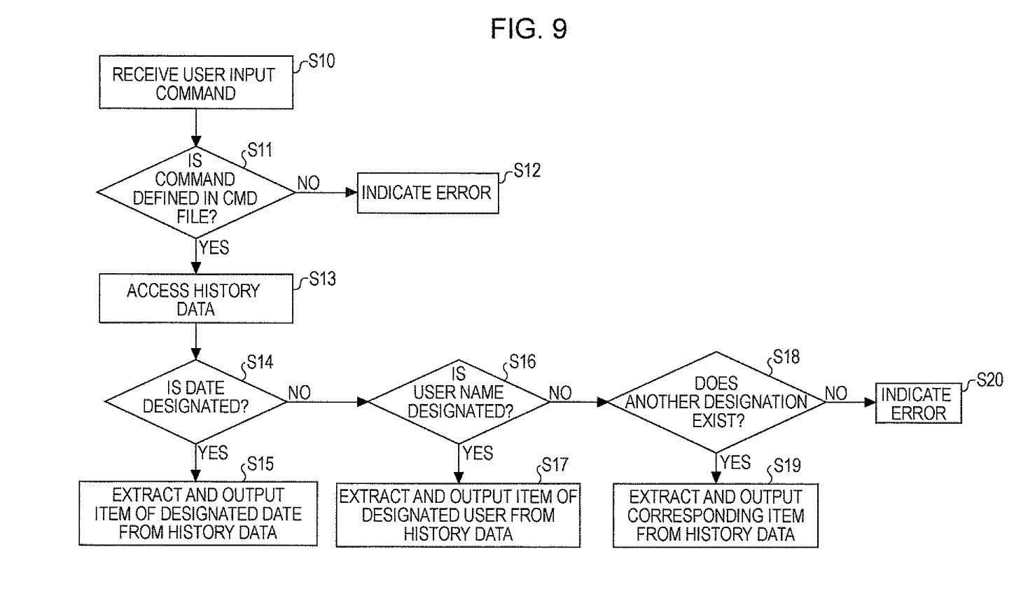

FIG. 9 is a flowchart of a history data selection process. The history data selection process is performed by the history data extractor 26 in the CPU of the design support apparatus 1. The design support apparatus 1 receives a command entered by a user (operation S10). The design support apparatus 1 determines whether the entered command is defined in the command file (CMD) 13 (operation S11). If it is determined in operation S11 that the entered command is not defined in the command file 13, the design support apparatus 1 indicates an error message (operation S12).

If it is determined in operation S11 that the entered command is defined in the command file 13, the design support apparatus 1 accesses history data (operation S13).

Then, the design support apparatus 1 determines whether a date is designated in a parameter of the command (operation S14). If it is determined in operation S14 that a date is designated, the design support apparatus 1 extracts an item corresponding to the designated date (corresponding history data) from the history data (operation S15).

If it is determined in operation S14 that a date is not designated, the design support apparatus 1 determines whether a user name is designated (operation S16). If it is determined in operation S16 that a user name is designated, the design support apparatus 1 extracts an item corresponding to the designated user name from the history data (operation S17).

If it is determined in operation S16 that a user name is not designated, the design support apparatus 1 determines whether another designation exists (operation S18). Here, another designation includes another definition in the rule file 11, such as designation of an “Initial” command, an “Add” command, or the like. In addition, another designation is a parameter of history data as illustrated in FIG. 6A, such as the value of “before”, “after”, “layer”, “via”, “X1”, “Y1”, “X2”, “Y2”, or the like. If it is determined in operation S18 that another designation exists, the design support apparatus 1 extracts a corresponding item from the history data (operation S19).

If it is determined in operation S18 that another designation does not exist in the command, the design support apparatus 1 indicates an error message (operation S20). After the processing of operations S12, S15, S17, S19, and S20, the design support apparatus 1 returns to operation S10.

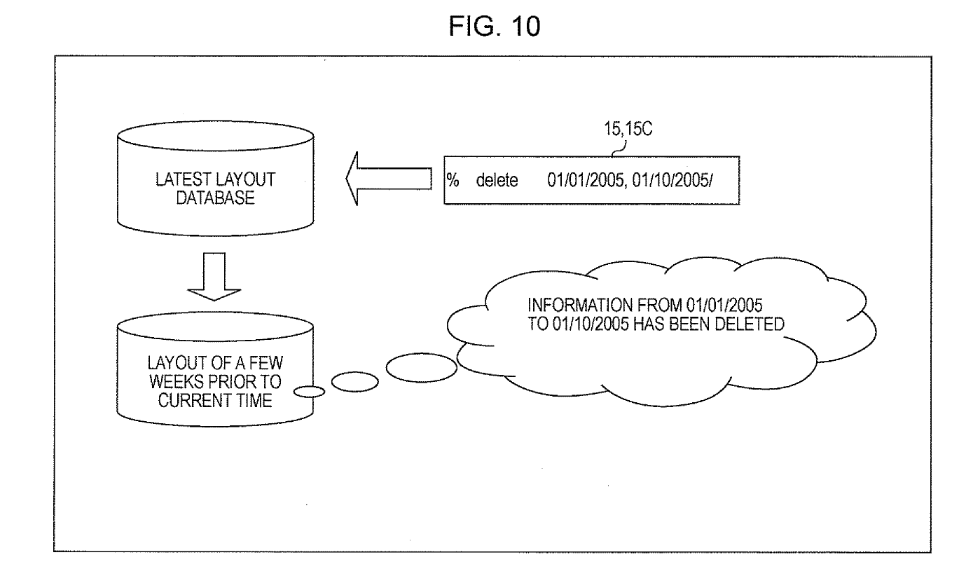

FIG. 10 schematically illustrates a processing for restoring design data to a state that was present at a certain time prior to the current time. In this processing, a user enters a command, such as “delete 1/1/2005, 1/10/2005”, on a command entry screen 15C. This command instructs deletion of update contents from Jan. 1, 2005 to Jan. 10, 2005. If the current date is Jan. 10, 2005, processing for restoring design data of ten days prior to the current date is performed. Accordingly, the design support apparatus 1 extracts corresponding history data, and performs restoration for design data corresponding to the history data for each record of history data, that is, for each row shown in FIG. 6A. Accordingly, design data of ten days prior to the current date can be restored.

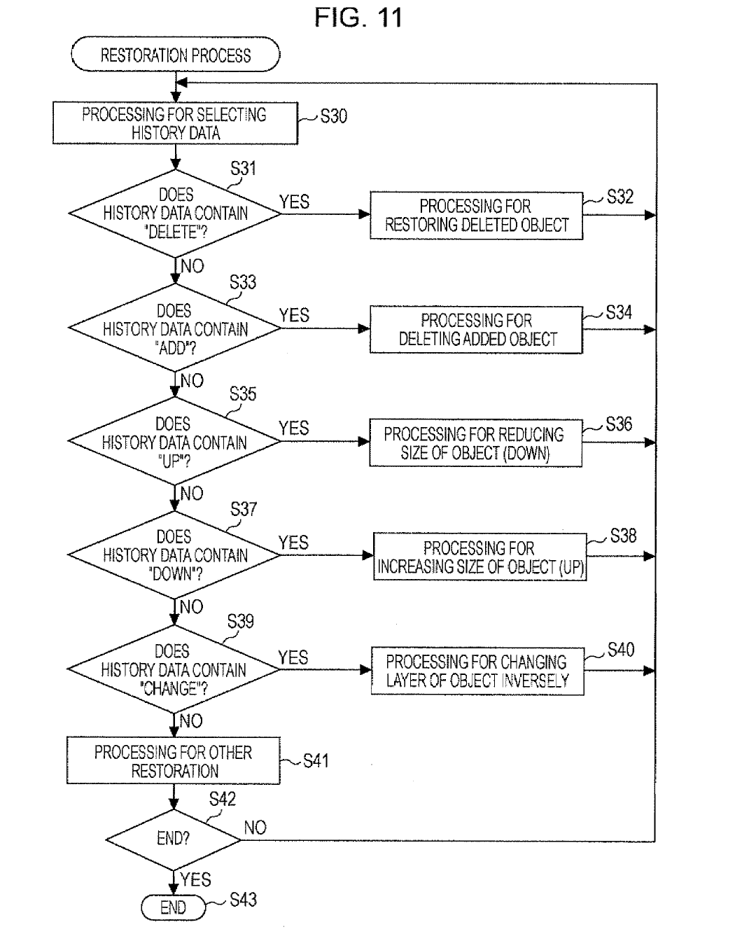

FIG. 11 is a flowchart of a restoration process. The design support apparatus 1 performs history selection processing (operation S30). Since the history selection processing is substantially similar to the processing shown in FIG. 9, the description of the history selection processing will be omitted.

The design support apparatus 1 determines whether selected history data contains a “Delete” command (operation S31). If it is determined in operation S31 that the selected history data contains a “Delete” command, a deleted object is restored (operation S32). For example, if the deleted object is a gate, the gate is disposed again in the design data in accordance with the cell name and the position coordinates of the gate, which are described in the history data. It is assumed that, in the design support apparatus 1, attributes, such as the gate size and the like, have already been defined in the design data in association with the cell name. In addition, if the deleted object is a line, the line recorded in the history data is added again. The attributes of the line, such as the width of the line and the like, are recorded before the “Delete” command in the history data. Then, the design support apparatus 1 returns to operation S30.

If it is determined in operation S31 that the selected history data does not contain a “Delete” command, the design support apparatus 1 determines whether the selected history data contains an “Add” command (operation S33). If it is determined in operation S33 that the selected history data contains an “Add” command, the design support apparatus 1 deletes an added object (operation S34). For example, if a gate was added as an object, the object is deleted in accordance with the name of a cell and the coordinates of the gate. If a line is added as an object, the position of the line is specified in accordance with the history data and the line is deleted. Then, the design support apparatus 1 returns to operation S30.

If it is determined in operation S33 that the selected history data does not contain an “Add” command, the design support apparatus 1 determines whether the selected history contains an “Up” command (operation S35). If it is determined in operation S35 that the selected history data contains an “Up” command, the design support apparatus 1 reduces the size of a corresponding object to the original size (operation S36). Then, the design support apparatus 1 returns to operation S30.

If it is determined in operation S35 that the selected history data does not contain an “Up” command, the design support apparatus 1 determines whether the selected history data contains a “Down” command (operation S37). If it is determined in operation S37 that the selected history data contains a “Down” command, the design support apparatus 1 increases the size of a corresponding object to the original size (operation S38). Then, the design support apparatus 1 returns to operation S30.

If it is determined in operation S37 that the selected history data does not contain a “Down” command, the design support apparatus 1 determines whether the selected history data contains a “Change” command (operation S39). If it is determined in operation S39 that the selected history data contains a “Change” command, the design support apparatus 1 returns the layer of a corresponding object to the original layer before updating (changes the layer inversely) (operation S40). Then, the design support apparatus 1 returns to operation S30.

If it is determined in operation S39 that the selected history data does not contain a “Change” command, the design support apparatus 1 performs the restoration process for another updating (operation S41). Then, the design support apparatus 1 determines whether an instruction to terminate the restoration process has been issued (operation S42). If it is determined in operation S42 that an instruction to terminate the restoration process has not been issued, the design support apparatus 1 returns to operation S30. If it is determined in operation S42 that an instruction to terminate the restoration process has been issued, the design support apparatus 1 terminates the restoration process (operation S43).

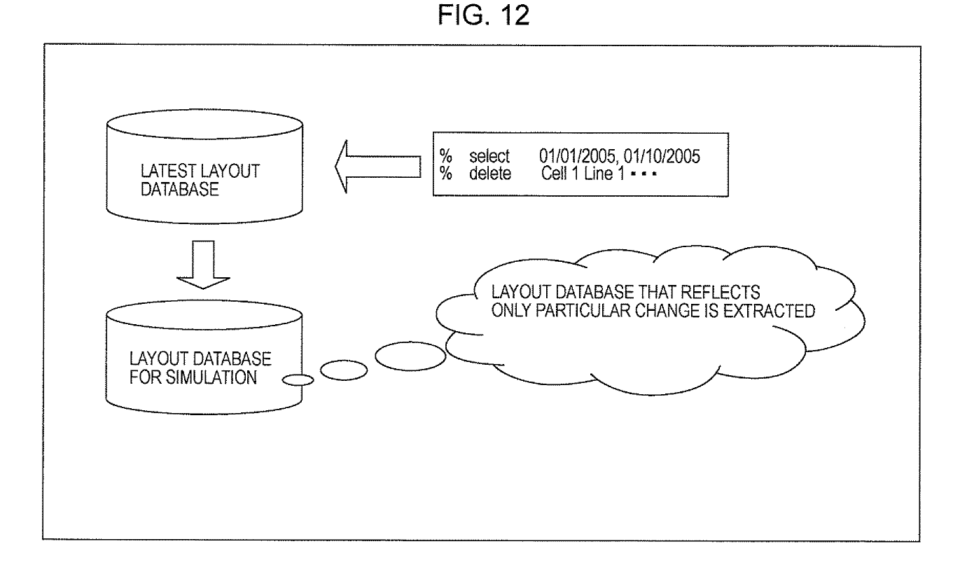

FIG. 12 shows an example of a processing for performing simulation that reflects only particular updating. In this example, for example, the contents of updating performed from Jan. 1, 2005 to Jan. 10, 2005 are extracted in accordance with a command “select 1/1/2005, 1/10/2005”. Then, unwanted updating among the extracted update contents is deleted in accordance with a command “delete Cell1 Line1 . . . ”. Then, the result is stored as a database for simulation. A circuit simulation is performed in accordance with design data (layout) of the database for simulation.

Accordingly, a circuit simulation can be performed in accordance with design data in which only a necessary portion has been updated. For example, if updating was performed for a plurality of purposes (for example, avoidance of setup errors, avoidance of hold errors, reduction of power consumption, avoidance of logic errors, and the like) during the period from Jan. 1, 2005 to Jan. 10, 2005, a simulation can be performed such that only a particular purpose portion, for example, only a result of updating performed in order to reduce power consumption, is maintained and that design data of the other portions updated for the other purposes can be restored to the state present before the updating was performed.

In the example shown in FIG. 12, particular update contents are maintained and the other updates are deleted (restored) in accordance with the commands “select” and “delete”, However, if an object to be restored can be specified in accordance with a parameter of a command, a database for simulation that reflects only necessary updating can be generated in accordance with designation of a command. For example, an object to be deleted can be designated using a parameter, such as a date, a user name, a cell name, “setup”, “hold”, “logic”, or the like, as a parameter of a “delete” command.

As described above, in the case of layout design of a circuit, the design support apparatus 1 according to an embodiment of the present invention is capable of recording, as history data, which portion of which data (a gate, a line, or the like) was updated from what to what when, by whom, and for what purpose. Thus, for example, even in a case where a plurality of operators perform layout design at the same time, the contents of operations can be shared between them. Thus, occurrence of disagreement or discrepancy in layouts can be reduced. In addition, since the purpose of an operation performed by the previous operator is recorded as history data, the present operator can understand the purpose of the previous operation and can perform an updating operation.

In addition, selection processing can be performed for history data in accordance with a date, a user name, the type of intended data (a gate, a line, or the like), a cell name, a line name, the purpose of updating, or the like. Thus, update history data desired by a user can be selected. For example, an update state present at a desired point in time can be restored by deleting an update content corresponding to the selected history data.

In addition, only updating corresponding to a desired parameter can be deleted or maintained and design data that reflects only updating in which a user is interested can be extracted. For example, if an extraction result is input to a circuit simulator, a circuit simulation focused on only updating in which the user is interested can be achieved.

In the above-described embodiments, an update content is input to the design support apparatus 1 when the user enters a command in response to a prompt appearing on the command entry screen 15, as shown in FIG. 2. However, instead of such a configuration, an update command for the rule file 11, which represents an update content, and a command for the command file 13 may be set in a text file. The text file containing a series of commands representing update contents may be input to the design support apparatus 1. The design support apparatus 1 analyzes a command of such a text file for each row, and performs processing for determining whether the command is defined in the rule file 11 and the command file 13, updating the layout database 14, storing history data, extracting designated history data, deleting updating corresponding to the history data, restoring data before updating, and the like.

A program for causing a computer, a machine, or an apparatus (hereinafter, generically referred to as a computer or the like) to attain any of the above-described functions can be recorded in a recording medium that can be read by a computer or the like. The above-described functions can be provided by causing the computer or the like to read and execute the program recorded in the recording medium.

The recording medium that can be read by the computer or the like is a recording medium that is capable of storing data and information on a program and the like by electric, magnetic, optical, mechanical, or chemical operations and reading the data and the information from the computer or the like. A recording medium that can be removed from the computer or the like is, for example, a flexible disk, a magneto-optical disk, a CD-ROM, a CD-RAN, a DVD, a digital audio tape (DAT), an 8-mm tape, a memory card, or the like.

In addition, as a recording medium fixed to the computer or the like, a hard disk, a read-only memory (ROM), or the like can be used.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A design support apparatus comprising:
an editor generating design data of a circuit including circuit components and a line connecting the circuit components, and updating the design data;
a design database storing the design data of the circuit;
a history database storing update history data representing an update content in association with an updated circuit component or an updated line in the design data when the design data is updated;
an extraction criterion receiver receiving an extraction criterion for extracting a particular piece of update history data from among a plurality of pieces of update history data stored in the history database;
a history data extractor extracting the update history data from the history database in accordance with the extraction criterion; and
a restoring unit restoring an original design data of the circuit before said updating as represented by the update history data extracted.

2. The design support apparatus according to claim 1, comprising:
an update designation unit receiving a designation of an update content in association with a circuit component to be updated or a line to be updated in the design data of the circuit; and
a history data controller storing into the history database update history data containing the update content in association with the updated circuit component or the updated line when the editor updates the design data in accordance with the designation received from the update designation unit.

3. The design support apparatus according to claim 1, wherein the update content includes at least one of an addition of a circuit component, a deletion of the circuit component, and a change in a size of the circuit component, and
the change in the size is described using sizes of the circuit component before and after the change.

4. The design support apparatus according to claim 1, wherein the update content includes at least one of an addition of a line, a deletion of the line, a change in a size of the line, and a change of a layer to which the line belongs,
the change in the size is described using sizes of the line before and after the change, and
the change of the layer is described using layer identification information for identifying layers to which the line belongs before and after the change.

5. A method for supporting a design, comprising:
generating design data of a circuit including circuit components and a line connecting the circuit components and updating the design data;
storing the design data of the circuit and storing update history data representing an update content in association with an updated circuit component or an updated line in the design data when the design data is updated;
receiving an extraction criterion for extracting a particular piece of update history data from among a plurality of pieces of update history data stored in the history database;
extracting the update history data from a history database in accordance with the extraction criterion; and
restoring an original design data of the circuit before said updating as represented by the update history data extracted.

6. The method according to claim 5, comprising:
receiving a designation of an update content in association with a circuit component to be updated or a line to be updated in the design data of the circuit; and
executing a history data control operation of, storing into the history database update history data containing the update content in association with the updated circuit component or the updated line when an editor updates the design data in accordance with the designation.

7. The method according to claim 5, wherein the update content includes at least one of an addition of a circuit component a deletion of the circuit component, and a change in a size of the circuit component, and
the change in the size is described using sizes of the circuit component before and after the change.

8. The method according to claim 5, wherein the update content includes at least one of an addition of a line, a deletion of a line, a change in a size of the line, and a change of a layer to which the line belongs,
the change in the size is described using sizes of the line before and after the change, and
the change of the layer is described using layer identification information for identifying layers to which the line belongs before and after the change.

9. A computer-readable storage medium in which a program for a design support apparatus is stored causing a computer to execute operations, comprising:
generating design data of a circuit including circuit components and a line connecting the circuit components and updating the design data;
storing the design data of the circuit and storing update history data representing an update content in association with an updated circuit component or an updated line in the design data when the design data is updated;
receiving an extraction criterion for extracting a particular piece of update history data from among a plurality of pieces of update history data stored in the history database;
extracting the update history data from the history database in accordance with the extraction criterion; and
restoring the original design data of the circuit before updating as represented by the update history data extracted.

10. The computer-readable storage medium according to claim 9, comprising:
receiving an update designation of an update content in association with a circuit component to be updated or a line to be updated in the design data of the circuit; and
executing a history data control operation of, storing update history data containing the update content in association with the updated circuit component or the updated line when an editor updates the design data in accordance with the update designation.

11. The computer-readable storage medium according to claim 9, wherein the update content includes at least one of an addition of a circuit component, a deletion of the circuit component, and a change in a size of the circuit component, and
the change in the size is described using sizes of the circuit component before and after the change.

12. The computer-readable storage medium according to claim 9, wherein the update content includes at least one of an addition of a liner a deletion of the line, a change in a size of the line, and a change of a layer to which the line belongs,
the change in the size is described using sizes of the line before and after the change, and
the change of the layer is described using layer identification information for identifying layers to which the line belongs before and after the change.
